(19) United States
(12) Patent Application Publication
(10) Pub. No.: US 2026/0183690 A1
(43) Pub. Date: Jul. 2, 2026

(54) REUSABLE MULTI-POCKET V-BANK AIR FILTER

(71) Applicant: K&N Engineering, Inc., Corona, CA (US)

(72) Inventor: Steve Williams, Cherry Valley, CA (US)

(73) Assignee: K&N Engineering, Inc., Corona, CA (US)

(21) Appl. No.: 19/434,269

(22) Filed: Dec. 29, 2025

Related U.S. Application Data
(60) Provisional application No. 63/740,674, filed on Dec. 31, 2024.

(51) Int. Cl. B01D 46/121; B01D 46/00; F24F 8/108; F24F 13/28

(52) U.S. Cl. CPC B01D 46/121; B01D 46/0005; F24F 8/108; F24F 13/28; B01D 2279/50

(57) ABSTRACT

An apparatus and methods are provided for a reusable multi-pocket V-bank air filter to remove contaminants from air within interior building environments. The air filter includes multiple reusable filter bags for filtering an airstream. A frame supports the filter bags in V-configurations within an HVAC system. Adjacent filter bags are offset from one another and extend in the V-configurations downstream of the frame when the airstream flows into the filter bags. Elongated openings in the frame allow the airstream to flow through the frame into the filter bags. The elongated openings include filter bag retainers for individually coupling the filter bags with the frame. The filter bags can be removed from the frame for servicing without removing the frame from the HVAC system. The filter bags can be cleaned by removing them from the air filter, flushing contaminants from the filter bags, and allowing the filter bags to dry.

### PRIORITY

This application claims the benefit of and priority to U.S. Provisional Application, entitled “Reusable Multi-Pocket V-Bank Air Filter,” filed on Dec. 31, 2024, and having application Ser. No. 63/740,674, the entirety of said application being incorporated herein by reference.

### FIELD

Embodiments of the present disclosure generally relate to filter devices. More specifically, embodiments of the disclosure relate to an apparatus and methods for a reusable multi-pocket V-bank air filter to remove airborne molecular contaminants and volatile organic compounds from air within interior building spaces.

### BACKGROUND

Heating, ventilation, and air conditioning (HVAC) systems generally operate to provide optimal indoor air quality to occupants within interior building spaces. HVAC systems achieve optimal indoor air quality by conditioning air, removing particle contaminants by way of ventilation and filtration of air, and providing proper building pressurization.

While there are many different HVAC system designs and operational approaches, and each building design is unique, HVAC systems generally share a few basic design elements. For example, outside air (“supply air”) generally is drawn into a HVAC system of a building through an air intake. Once in the HVAC system, the supply air is filtered to remove particle contaminants, then heated or cooled, and then circulated throughout the building by way of an air distribution system. Many air distribution systems comprise a return air system configured to draw air from interior building spaces and return the air (“return air”) to the HVAC system. The return air is then mixed with supply air and then filtered, conditioned, and circulated throughout the building. Often times, a portion of the air circulating within the building may be exhausted to the exterior of the building so as to maintain a desired barometric pressure within the building.

As will be appreciated, the effectiveness of the HVAC system to provide an optimal indoor air quality depends largely on an ability of an air filter within the HVAC system to remove particle contaminants from the air within the building. A HVAC system air filter typically comprises fibrous materials configured to remove solid particulates, such as dust, pollen, mold, and bacteria from the air passing through the HVAC system. A drawback to conventional HVAC system air filters, however, is that highly effective air filters capable of removing very small contaminants, such as airborne molecular contaminants and volatile organic compounds (VOCs), tend to restrict airflow through the air filter, thereby making the HVAC system work harder and consume more energy.

Another drawback to conventional HVAC system air filters is that dirty or clogged air filters typically are removed from the HVAC system and discarded, and a new HVAC system air filter is then installed. Further, HVAC system air filters may be unnecessarily discarded and replaced in an effort to increase HVAC system airflow and thus decrease operation costs. Considering that there are millions of buildings with HVAC systems throughout the world, the volume of discarded air filters that could be eliminated from landfills is staggering.

What is needed, therefore, is an air filter that may be periodically cleaned and reused and is configured for removing airborne molecular contaminants and VOCs from air within interior building spaces without obstructing air flow through the air filter.

### SUMMARY

An apparatus and methods are provided for a reusable multi-pocket V-bank air filter to remove contaminants from air within interior building environments. The reusable multi-pocket V-bank air filter comprises a multiplicity of reusable filter bags for filtering an airstream. A frame supports the filter bags in one or more V-configurations within an HVAC system. Adjacent filter bags are offset from one another and extend in the V-configuration downstream of the frame when the airstream flows into the filter bags. Elongated openings in the frame allow the airstream to flow through the frame into the filter bags. The elongated openings include filter bag retainers for individually coupling the filter bags with the frame. The filter bags can be removed from the frame for servicing without removing the frame from the HVAC system. The filter bags can be cleaned by removing them from the multi-pocket air filter, flushing contaminants from the filter bags, and allowing the filter bags to dry.

In an exemplary embodiment, an apparatus for a multi-pocket V-bank air filter to clean air in interior building environments comprises: a multiplicity of reusable filter bags for filtering an airstream; a frame for supporting the multiplicity of filter bags in one or more V-configurations within an HVAC system; elongated openings disposed in the frame for allowing the airstream to flow through the frame; and filter bag retainers disposed in the elongate openings for coupling the filter bags with the frame.

In another exemplary embodiment, the frame is formed of a rigid material suitable for supporting the multiplicity of filter bags within the HVAC system. In another exemplary embodiment, the frame comprises a first end, a second end, and multiple ribs arranged parallelly therebetween. In another exemplary embodiment, the first end and the second end each includes a series of rounded end portions that define opposite ends of the elongated openings. In another exemplary embodiment, the frame orients the multiplicity of filter bags within the HVAC system such that the return airstream is directed through the filter bags. In another exemplary embodiment, the elongated openings keep entrances into the filter bags open to allow the return airstream to flow through the frame into the filter bags.

In another exemplary embodiment, the first end and the second end are configured to offset adjacent elongated openings to support the multiplicity of filter bags in the V-configuration within an HVAC system. In another exemplary embodiment, the first end, the second end, the rounded end portions, and the ribs comprise separate components that can be assembled to offset the elongated openings. In another exemplary embodiment, the elongated openings comprise preassembled portions that can be retained in position by first end and the second end. In another exemplary embodiment, the first end and the second end include seats configured to engage with rounded end portions comprising opposite ends of the elongated openings to hold the elongated openings in fixed positions. In another exemplary embodiment, the first end, the second end, the rounded end portions, and the ribs comprise a single monolithic component.

In another exemplary embodiment, the elongated openings are arranged between the first end and the second end such that the multiplicity of filter bags extend into the one or more V-configurations downstream of the frame when the return airstream flows into the filter bags. In another exemplary embodiment, the one or more V-configurations are configured to provide a relatively greater spacing between adjacent filter bags and reduce resistance to airflow the filter bags.

In another exemplary embodiment, an upstream panel air filter is coupled with the frame. In another exemplary embodiment, the panel air filter comprises a primary filter while the multiplicity of reusable filter bags comprises a secondary filter. In another exemplary embodiment, the primary filter has a lower MERV rating than the MERV rating of the secondary filter. In another exemplary embodiment, the primary filter is coupled with the secondary filter by way of a hinge and a clasp.

In another exemplary embodiment, the primary filter is configured to be easily removed, cleaned, and reinstalled into the HVAC system to preserve the operating efficiency of the HVAC system. In another exemplary embodiment, the primary filter is configured to be uninstalled from the secondary filter without the secondary filter having to be removed from the HVAC system. In another exemplary embodiment, the primary filter is configured to receive a filter oil composition that enables the primary filter to capture contaminants by way of interception.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a cross-sectional view of an exemplary-use environment wherein a multi-pocket V-bank air filter is incorporated into a HVAC system of a building, according to the present disclosure;

FIG. 2 illustrates a schematic view of an exemplary embodiment of a HVAC system comprising a multi-pocket V-bank air filter in accordance with the present disclosure;

FIG. 3 illustrates a perspective view of an exemplary embodiment of a multi-pocket V-bank air filter that may be used to clean an airstream flowing through a HVAC system to clean air within interior building spaces;

FIG. 4 illustrates a front view of an exemplary embodiment of a supportive frame comprising elongated openings and rounded end portions configured for a multi-pocket V-bank air filter in accordance with the present disclosure;

FIG. 5 illustrates a top view of an exemplary embodiment of a multi-pocket V-bank air filter cleaning an inflowing airstream in accordance with the present disclosure;

FIG. 6 illustrates a perspective view of an exemplary embodiment of a filter bag comprising a filter medium that provides an area through which to pass an airstream and entrap particulates and other contaminates flowing with the airstream, according to the present disclosure;

FIG. 7 illustrates a side view of an exemplary embodiment of a multi-pocket V-bank air filter that includes planar supports coupled with filter bags and configured to prevent an inflowing airstream from bulging the filter bags, according to the present disclosure;

FIG. 8 illustrates a side view of an exemplary embodiment of a filter bag that includes a first filter sheet and a second filter sheet that can be separated to simplify flushing contaminants from an interior of the filter bag. In accordance with the present disclosure; and

FIG. 9 illustrates a cross-sectional view of an exemplary embodiment of a multi-pocket V-bank air filter that is coupled with an upstream, primary air filter, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the reusable multi-pocket air filter and methods disclosed herein may be practiced without these specific details. In other instances, specific numeric references such as “first pocket,” may be made. However, the specific numeric reference should not be interpreted as a literal sequential order but rather interpreted that the “first pocket” is different than a “second pocket.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, HVAC systems operate to provide optimal indoor air quality to occupants within interior building spaces. HVAC systems achieve optimal indoor air quality by conditioning air, removing particle contaminants by way of ventilation and filtration of air, and providing proper building pressurization. The effectiveness of an HVAC system to provide optimal indoor air quality depends largely on the ability of an air filter within the HVAC system to remove particle contaminants from the air within the building. A drawback to many conventional HVAC system air filters, however, is that highly effective air filters capable of removing very small contaminants tend to restrict airflow through the air filter, thereby making the HVAC system work harder and consume more energy. Another drawback to conventional HVAC system air filters is that dirty or clogged air filters typically must be removed from the HVAC system and discarded, sometimes prematurely, before a new HVAC system air filter can be installed. Embodiments presented herein provide a reusable multi-pocket V-bank air filter configured to remove airborne molecular contaminants and VOCs from air within interior building spaces.

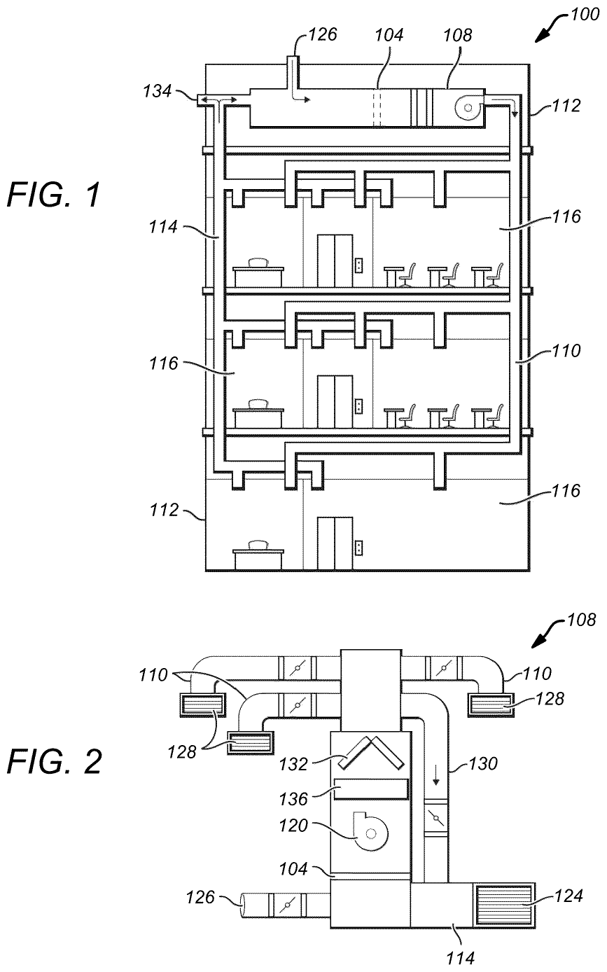

FIG. 1 illustrates an exemplary-use environment 100 wherein an air filter 104 is incorporated into a HVAC system 108 of a building 112 to clean an airstream drawn through the air filter 104. Although the building 112 illustrated in FIG. 1 comprises a multi-story office building, it should be understood that the building 112 may comprise any of various structures, such as warehouses, storage spaces, server rooms, clean rooms, office spaces, residential homes, apartments, condominiums, and the like, without limitation. After passing through the air filter 104, the airstream is routed into one or more building spaces 116 by way of a supply ductwork 110. Air within the building spaces 116 is routed back to the HVAC system 108 by way of a return ductwork 114. It will be appreciated that the building 112 may comprise multiple stories, each of which stores including one or more building spaces 116, as illustrated in FIG. 1, or may comprise a single-story building, including but not limited to a detached residential home.

FIG. 2 illustrates a schematic view of an exemplary embodiment of a HVAC system 108 that may be used to clean air within building spaces 116. The HVAC system 108 generally comprises a fan 120 configured to draw a return airstream 124 from the building spaces 116 through the air filter 104 whereby airborne molecular contaminants, VOCs, and other particle contaminants are removed from the airstream. Particle contaminants removed from the return airstream 124 are entrapped in the air filter 104. The fan 120 then pushes a clean airstream 128 through an air conditioning system 132 and a heater core 136 and then into the building spaces 116. As will be appreciated, the air conditioning system 132 and the heater core 136 facilitate providing a consistent, comfortable temperature within the building spaces 116 by respectively cooling and heating the clean airstream 128, as needed. As further shown in FIG. 2, the return airstream 124 may be combined with an outside airstream 126, as well as with a bypass airstream 130 airstream so as to maintain a desired barometric pressure within the HVAC system 108 and within the building spaces 116. In some embodiments, an exhaust airstream 134 (see FIG. 1) may be further incorporated into the HVAC system 108 to maintain the desired barometric pressure and to allow entry of the outside airstream 126.

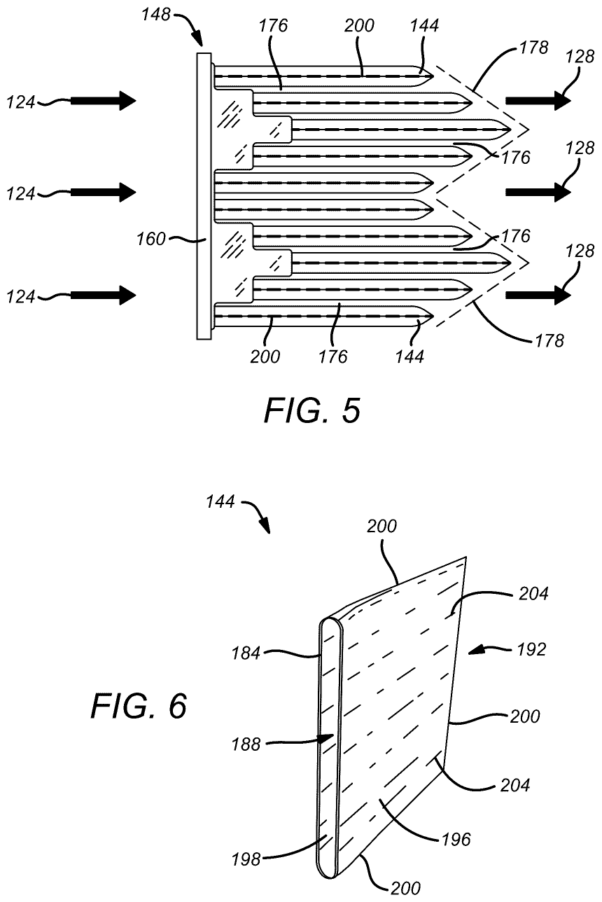

FIG. 3 illustrates an exemplary embodiment of a multi-pocket V-bank air filter 140 according to the present disclosure. The multi-pocket V-bank air filter 140 (hereinafter, “pocket air filter 140”) comprises a multiplicity of filter bags 144 coupled with a supportive frame 148. The supportive frame 148 includes a multiplicity of elongated openings 152 that allow a return airstream 124 to flow into the filter bags 144, as shown in FIG. 5, and a clean airstream 128 to exit the filter bags 144. The pocket air filter 140 can be used to filter air in clean room environments. For example, pocket air filters 140 may be implemented as pre-filters before HEPA filters. The filter bags 144 provide more surface area than conventional filters, reduce an overall pressure drop in the HVAC system 108, and extend the life of downstream filters.

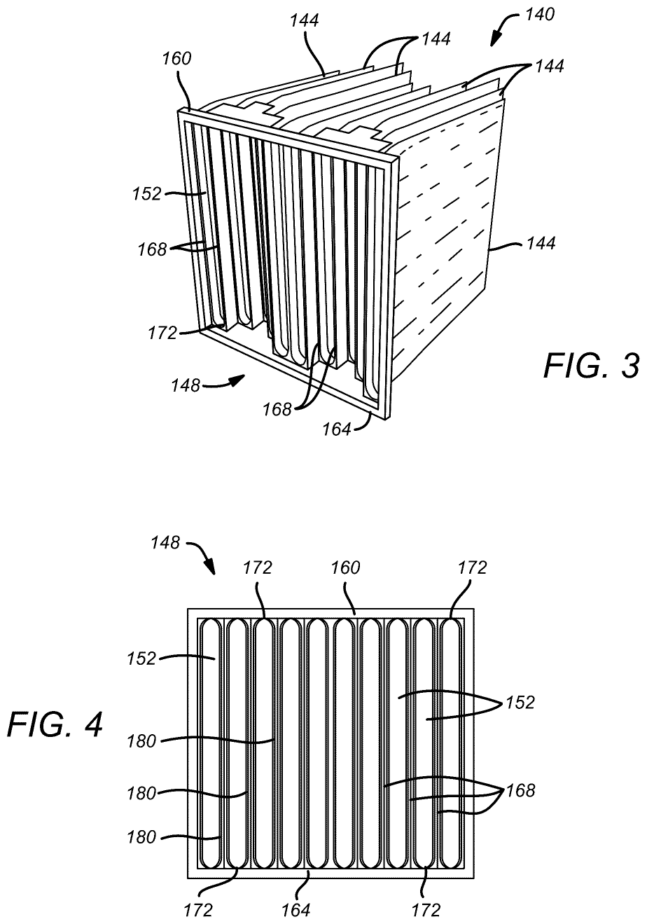

As shown in FIGS. 3-4, the frame 148 comprises a first end 160, a second end 164, and multiple ribs 168 arranged parallelly therebetween. The first and second ends 160, 164 each includes a series of rounded end portions 172 that define opposite ends of the elongated openings 152. The frame 148 is configured to orient the pocket air filter 140 within the HVAC system 108 such that the return airstream 124 is directed through the filter bags 144. As such, the elongated openings 152 are configured to keep entrances into the filter bags 144 open to allow the return airstream 124 to flow through the frame 148 into the filter bags 144. It is contemplated that the frame 148 may be formed of any rigid material suitable for supporting the pocket air filter 140 within the HVAC system 108. Further, it should be understood that the shape and size of the frame 148 will generally vary depending upon the make and model of the HVAC system 108 for which the pocket air filter 140 is intended to be used.

In general, the pocket air filter 140 comprises two or more filter bags 144 that are coupled with the frame 148. As best shown in FIG. 5, the filter bags 144 are arranged parallel to one another and extend downstream of the frame 148 when the return airstream 124 flows into the filter bags 144. Preferably, the filter bags 144 are coupled with the frame 148 such that a space 176 is disposed between adjacent filter bags 144. It is contemplated that spaces 176 provide an unobstructed airflow through the sides of the filter bags 144.

Moreover, the first and second ends 160, 164 are configured in a manner that offsets adjacent elongated openings 152. In some embodiments, the first and second ends 160, 164 as well as the rounded end portions 172 and the ribs 168 comprise separate components that can be assembled to form the offset elongated openings 152 shown in FIG. 1. In some embodiments, however, the elongated openings 152 comprise preassembled portions that can be retained in position by first and second ends 160, 164. To this end, the first and second ends 160, 164 may include seats or other features (not shown) configured to engage with the rounded end portions 172 to hold opposite ends of the elongated openings 152 in fixed positions, as shown in FIG. 1. It is contemplated, however, that in some embodiments, the first and second ends 160, 164 as well as the rounded end portions 172 and the ribs 168 comprise a single monolithic component that can be formed by injection molding, 3D printing, or another suitable process, to form the offset elongated openings 152 shown in FIG. 1.

As best shown in FIG. 5, the elongated openings 152 are arranged between the first and second ends 160, 164 such that the filter bags 144 extend into one or more V-configurations 178 downstream of the frame 148 when the return airstream 124 flows into the filter bags 144. In the illustrated embodiment, the pocket air filter 140 comprises ten filter bags 144 arranged into two V-configurations 178. It is contemplated, however, that other embodiments, any number of filter bags 144 can be arranged into any desired number of V-configurations 178, without limitation. Further, given that the V-configurations 178 provide a relatively greater spacing between adjacent filter bags 144, it is contemplated that extending the filter bags 144 into the V-configurations 178 may reduce resistance to airflow through the pocket air filter 140.

In some embodiments, a gasket may be incorporated into the pocket air filter 140 to prevent the return airstream 124 from flowing around the frame 148 and thus bypassing the filter bags 144. For example, in some embodiments, a gasket may be configured to be disposed between an interior of the HVAC system 108 and the first and second ends 160, 164, as well as sides 162 of the frame 148 (see FIG. 1). In some embodiments, the gasket may be incorporated directly into the frame 148 to eliminate a need for a separately provided gasket. Thus, in embodiments wherein the frame 148 comprises separate components, the first and second ends 160, 164, and the sides 162 each can include a strip of material that operates as a gasket once the pocket air filter 140 is assembled as shown in FIG. 1. As will be appreciated, the strips can be disposed on the first and second ends 160, 164 and the sides 162 such that the strips form a continuous strip of gasket material that extends around the perimeter of the frame 148 once the pocket air filter 140 is assembled. It is contemplated that the strips of gasket material may comprise any material that is amenable to providing an airtight seal between the pocket air filter 140 and the interior of the HVAC system 108, without limitation.

As shown in FIG. 4, each of the elongated openings 152 includes a filter bag retainer 180. Each of the filter bag retainers 180 is configured to fixedly receive a mount portion 184 comprising each filter bag 144, as shown in FIG. 6. The filter bag retainers 180 can be any device or mechanism that is configured to retain the mount portions 184 of the filter bags 144. Further, the mount portions 184 can be any device or mechanism configured to be engaged with the filter bag retainers 180 to couple the filter bag 144 with the frame 148. For example, in an embodiment, the mount portion 184 may comprise a rigid lip configured to maintain an opening to an interior 188 of the filter bag 144, as shown in FIG. 6. And thus, the filter bag retainers 180 may comprise a series of clasps surrounding each of the elongated opening 152 that are configured to engage with and retain the rigid lip of the filter bag 144. It is contemplated that other specific embodiments of the filter bag retainers 180 and the mount portions 184 will be apparent to those skilled in the art.

Moreover, it should be understood that the filter bag retainers 180 and the mount portions 184 enable removing the filter bags 144 from the frame 148 individually. Thus, damaged or prematurely dirty filter bags 144 can be removed from the frame 148 and replaced with new filter bags 144 or previously cleaned filter bags 144 without having to discard other, undamaged or unclogged filter bags 144 that are coupled with the frame 148. Further, the filter bag retainers 180 and the mount portions 184 enable the pocket air filter 140 to be serviced without removing the frame 148 from the HVAC system 108. In an embodiment, dirty filter bags 144 can be disengaged with the frame 148 and removed from the HVAC system 108 for cleaning without disassembling the frame 148 from the HVAC system 108. In some embodiments, clean filter bags 144 may be installed into the frame 148 immediately after removing the dirty filter bags 144, thereby maintaining filtration of the return airstream 124 during the time while the dirty filter bags 144 are being cleaned and dried for reuse in the HVAC system 108.

Turning, now, to FIG. 6, each filter bag 144 comprises a filter medium 192 that provides an area through which to pass the return airstream 124 and entrap particulates and other contaminates flowing with the airstream 124. The filter medium 192 comprises a first filter sheet 196 and a second filter sheet 198 that are attached together along an edge support 200. The first and second filter sheets 196, 198 may be formed of paper, foam, cotton, spun fiberglass, or other known filter materials, woven or non-woven material, synthetic or natural, or any combination thereof. The first and second filter sheets 196, 198 provide a much larger filter surface area than traditional air filters.

In some embodiments, one or both of the first and second filter sheets 196, 198 may be a composite filter medium comprising one or more media layers, each having unique filtration properties such that the combination of media layers exhibits a relatively high filtration efficiency and a relatively low air pressure drop across the filter medium 192. For example, in one embodiment, one or both of the first and second filter sheets 196, 198 may comprise a first media layer and a second media layer. The first media layer may comprise a fiber density that is relatively lower than the fiber density of the second media layer. Thus, the filter medium 192 may comprise a fiber density that generally increases in the direction of air flow through the filter medium 192.

It is contemplated that the filter medium 192 can be periodically cleaned rather than replacing the entire pocket air filter 140, as is typically done with conventional air filter systems. As mentioned hereabove, it is envisioned that the pocket air filter 140 can be serviced by removing individual filter bags 144 from the pocket air filter 140 without having to remove the entire pocket air filter 140 from the HVAC system 108. Filter bags 144 can be cleaned by using a water hose to flush contaminants from the interior 188 of the filter bags 144 and then allowing the filter bags 144 to dry. Clean filter bags 144 can be installed into the frame 148 immediately after removing the dirty filter bags 144 so as to maintain filtration of the return airstream 124 during cleaning and drying the dirty filter bags 144 for reuse in the HVAC system 108. In some embodiments, however, the entire pocket air filter 140 can be removed from the HVAC system 108 to enable removing any trapped debris from the HVAC system 108.

In some embodiments, the filter medium 192 may comprise a dried synthetic material that generally becomes surface loaded as contaminants are deposited onto upstream surfaces of the filter medium 192 during use of the pocket air filter 140 in the HVAC system 108. As will be appreciated, the dried synthetic material may be cleaned by simply using a water hose to flush the contaminants from the filter medium 192. In some embodiments, the filter medium 192 may be cleaned by applying the water to downstream surfaces of the filter medium 192 to dislodge the contaminants from the upstream surfaces of the filter medium 192. In some embodiments, however, the filter medium 192 may be cleaned by applying higher-pressure water to the upstream surfaces of the filter medium 192 to flush the contaminants from the filter medium 192.

In some embodiments, the filter medium 192 may be configured to be treated with a filter oil composition. In such embodiments, the filter medium 192 may comprise a cotton gauze portion including 4 to 6 layers of cotton gauze coupled with at least one epoxy-coated aluminum wire screen. In some embodiments, the wire screen may be comprised of nylon, or other suitable thermoplastic material. The cotton may be advantageously treated with the filter oil composition so as to cause tackiness throughout microscopic strands comprising the filter medium 192. The nature of the cotton allows high volumes of airflow, and when combined with the tackiness of the filter oil composition creates a powerful filtering medium which ensures a high degree of air filtration.

In some embodiments, wherein the filter medium 192 includes a filter oil composition, a solvent may be used to remove the filter oil from the filter medium 192. Once the filter medium 192 has sufficiently dried, a suitably formulated filter oil composition may be applied and allowed to wick into the filter medium 192. The filter bag 144 may be reinstalled into the frame 148 disposed in the HVAC system 108, or, when the entire pocket air filter 140 is cleaned, dried, and reoiled, the pocket air filter 140 may then be reinstalled into the HVAC system 108. Various other cleaning methods will be apparent to those skilled in the art without deviating from the spirit and scope of the present disclosure.

During operation of the HVAC system 108, contaminant particles cling to the fibers within the volume of the filter medium 192 and become part of the filter medium 192, a process referred to as “depth loading.” Depth loading allows the pocket air filter 140 to capture and retain significantly more contaminants per unit of area than conventional air filters. Contaminant particles are stopped by the layers of cotton gauze and held in suspension by the filter oil composition, and thus the contaminants collected on the surface of the filter medium 192 have little effect on air flow during much of the service life of the pocket air filter 140. Moreover, as the filter medium 192 collects an increasing volume of contaminants and debris, an additional degree of filtering action begins to take place as the return airstream 124 first passes through the trapped contaminants on the surface of the filter medium 192 before passing through deeper layers within the filter medium 192. In essence, the trapped contaminants begin to operate as an additional filter material which precedes the filter medium 192. Thus, the pocket air filter 140 continues to exhibit a high degree of air flow and filtration throughout the service life of the filter, thereby reducing operating costs of the HVAC system 108.

As will be appreciated, treating the filter medium 192 with the filter oil composition generally enables the filter medium 192 to capture contaminants by way of interception, whereby contaminants, such as dirt particles, traveling with the return airstream 124 directly contact the fibers comprising the filter medium 192 and are then held in place by the filter oil composition. Larger or heavier particles generally are captured by way of impaction, whereby inertia or momentum of the particles causes them to deviate from the path of the return airstream 124 through the filter medium 192, and instead the particles run straight into the fibers and are captured by the filter oil composition.

Particle contaminants having very small sizes may be captured by way of diffusion. As will be appreciated, small particles are highly affected by forces within the return airstream 124 through the filter medium 192. Forces due to velocity changes, pressure changes, and turbulence caused by other particles, as well as interaction with air molecules, generally causes the small particles to follow random, chaotic flow paths through the filter medium 192. Consequently, the small particles do not follow the return airstream 124, and their erratic motion causes them to collide with the fibers comprising the filter medium 192 and remain captured by the filter oil composition. Diffusion and the filter oil composition enable the pocket air filter 140 to capture particle contaminants having sizes that are much smaller than the openings between the fibers comprising the filter medium 192. Furthermore, the filter oil composition enables the pocket air filter 140 to capture contaminants throughout the volume of the filter medium 192, rather than only on the surface of the filter as is common with conventional air filters. The multiple layers of cotton fibers comprising the filter medium 192 coupled with the tackiness provided by the filter oil composition provide many levels of contaminant retention, thereby enabling the pocket air filter 140 to hold significantly more contaminants per unit of area of the filter medium 192 than is possible with conventional air filters.

In some embodiments, the layers of cotton gauze treated with the filter oil composition may be coupled with portions of the filter medium 192 wherein other filtration mechanisms are used, thereby forming a composite filter medium 192 capable of removing airborne molecular contaminants and VOCs from the return airstream 124. For example, in some embodiments, the composite filter medium 192 may be comprised of a cotton gauze portion, as described herein, and an electrostatic portion. In such embodiments, the electrostatic portion of the composite filter medium 192 may be disposed downstream of the cotton gauze portion and configured to utilize electrostatic attraction and agglomeration to entrap particle contaminants. Thus, particle contaminants that would otherwise avoid directly colliding with fibers comprising the cotton gauze may be electrostatically captured and entrapped within the filter medium 192.

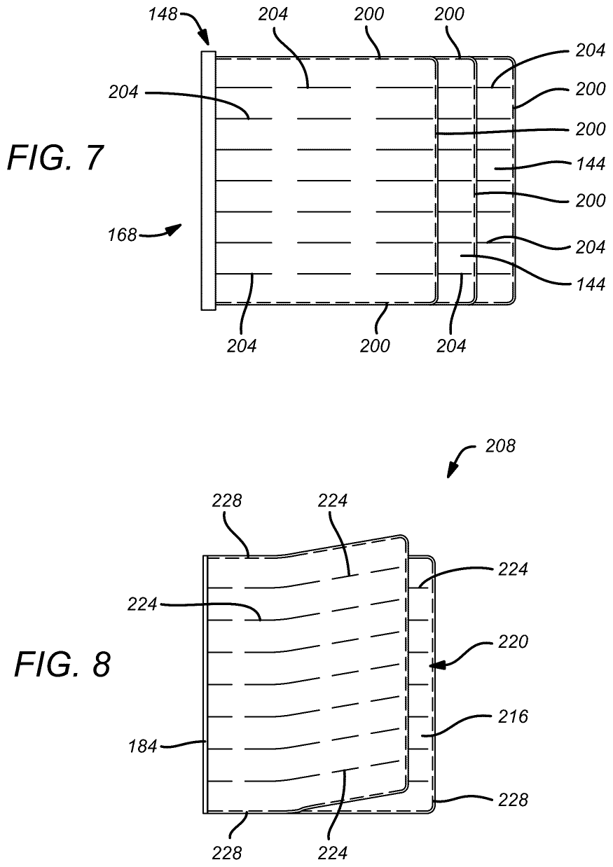

In the illustrated embodiment of FIGS. 6-7, planar supports 204 are embedded in the first and second filter sheets 196, 198 and configured to maintain the spaces 176 between the filter bags 144 shown in FIG. 5. The planar supports 204 may be any device configured to maintain the planar shape of the first and second filter sheets 196, 198, such as, by way of non-limiting example, thin wires of metal or plastic, metal or plastic wire screens, stitched portions of the sheets 196, 198, thicker portions of filter material that are sewn or adhered to the sheets 196, 198, and the like. It is contemplated that the planar supports 204 are configured to work in concert with the edge support 200 to prevent the first and second filter sheets 196, 198 from bulging outwards when the filter bags 144 receive the airstream 124.

In some embodiments, the edge support 200 comprises a rigid member, such as a metal wire, that is embedded along the perimeter of the filter bag 144, as shown in FIG. 7. The ends of the edge support 200 may terminate at the mount portion 184, shown in FIG. 6, or the ends of the edge support 200 may extend beyond the mount portion 184 and be configured to engage with the frame 148. For example, in some embodiments, the frame 148 may be configured to fixedly receive the ends of the edge support 200 in addition to retaining the mount portion 184 as described hereinabove. It is contemplated that the edge supports 200 serve to maintain the parallel positions of the filter bags 144 shown in FIG. 5.

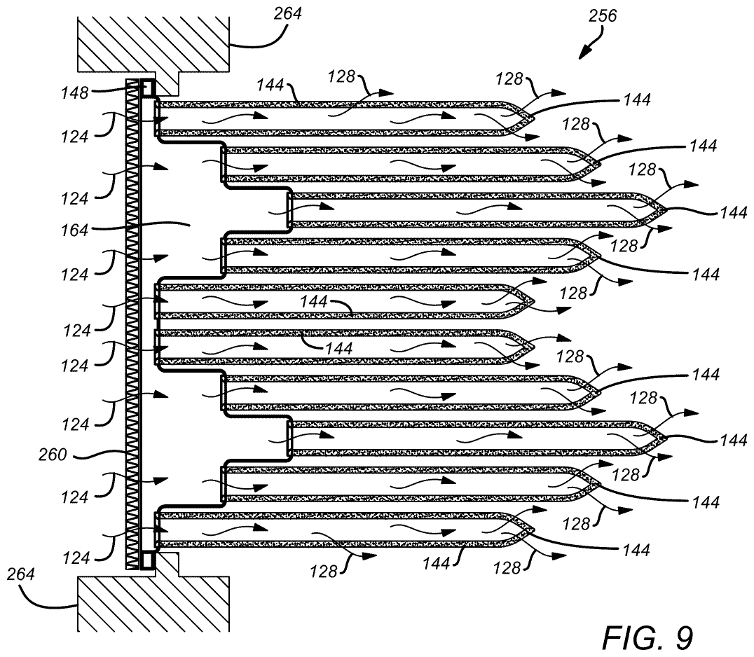

In some embodiments, the filter bag 144 may be configured to be openable to make cleaning the filter bag 144 easier. For example, FIG. 8 illustrates an exemplary embodiment of a filter bag 208 that includes a first filter sheet 212 and a second filter sheet 216 that can be separated to simplify flushing contaminants from an interior 220 of the filter bag 208. The first and second filter sheets 212, 216 may be attached along their edges by way of a closure such as a zipper, Velcro strips, or other similar device, without limitation. Similar to the filter bag 144 of FIG. 6, the filter bag 208 includes planar supports 224 embedded with the first and second filter sheets 212, 216. The planar supports 224 are configured to cooperate with an edge support 228 to prevent the first and second filter sheets 212, 216 from bulging outwards when the filter bag 208 receives the return airstream 124. The edge support 228 can be embedded along a perimeter of one or both of the first and second filter sheets 212, 216.

The filter bag 208 may be periodically cleaned by removing it from the pocket air filter 140, separating the first and second filter sheets 212, 216, and then using a water hose to flush contaminants from the interior 220 of the filter bag 208 before allowing the filter bag 208 to dry. In some embodiments, wherein the first and second filter sheets 212, 216, include a filter oil composition, a solvent may be used to remove the filter oil. Once the filter bag 208 has sufficiently dried, a suitably formulated filter oil composition may be applied and allowed to wick into the first and second filter sheets 212, 216. The filter bag 208 may be reinstalled into the frame 148 for continued use in the HVAC system 108. Various other cleaning methods will be apparent to those skilled in the art without deviating from the spirit and scope of the present disclosure.

Turning, now, to FIG. 9, a cross-sectional view of an exemplary embodiment of an air filter 256 is shown coupled with an upstream, panel air filter 260, according to the present disclosure. The air filter 256 shown in FIG. 9 is substantially identical to the pocket air filter 140 shown in FIGS. 3-5. In the embodiment illustrated in FIG. 9, a return airstream 124 flows through the panel air filter 260 before entering the air filter 256. As such, upon the return airstream 124 passing through filter bags 144 comprising the air filter 256, a clean airstream 128 exits the air filter 256 downstream of the filter bags 144.

In the embodiment illustrated in FIG. 9, the return airstream 124 flows through the panel air filter 260 before passing through the air filter 256. As such, the panel air filter 260 comprises a primary filter 260 while the air filter 256 comprises a secondary filter 256. It is contemplated that primary filter 260 can be used to remove a relatively large portion of the contaminants and VOCs flowing with the return airstream 124 so as to extend the longevity of the secondary filter 256. In some embodiments, the primary filter 260 may have a lower MERV rating than the MERV rating of the secondary filter 256. Since the cost of air filters is generally proportional to their MERV ratings, it is cost effective to replace or service the primary filter 260 more frequently than the secondary filter 256. In some embodiments, wherein the filters 256, 260 are configured to be reused, the primary filter 260 can be removed from the HVAC system 108 and cleaned with greater ease than removing and cleaning the secondary filter 256. As such, including the primary filter 260 discourages practitioners from putting off timely service intervals due to a perceived complexity of servicing the secondary filter 256.

As shown in FIG. 9, the filters 256, 260 are supported by way of structures 264. It should be understood that structures 264 comprise portions of the HVAC system 108 that are configured to support at least the secondary filter 256. In some embodiments, therefore, the primary filter 260 can be incorporated into the secondary filter 256. Thus, the primary filter 260 can be a removable portion of the secondary filter 256. For example, the primary filter 260 may be coupled with the secondary filter 256 by way of a hinge and a clasp (not shown). In such embodiments, the primary filter 260 may be removed from the second filter 256 by unfastening the clasp and then rotating the primary filter 260 away from the secondary filter 256 in a manner that resembles opening a door. Thus, the primary filter 260 may be uninstalled from the secondary filter 256 without the entire secondary filter 256 having to be removed from the structures 264. As such, the primary filter 260 can be easily removed, cleaned, and reinstalled into the HVAC system 108 to preserve the operating efficiency of the HVAC system 108.

In some embodiments, wherein the primary filter 260 includes a filter oil composition, a solvent may be used to remove the filter oil during cleaning the primary filter 260. After allowing the primary filter 260 to dry, a suitably formulated filter oil composition can be applied and allowed to wick into the primary filter 260. The primary filter 260 can then be reinstalled into secondary filter 256 within the HVAC system 108. Various other cleaning methods will be apparent to those skilled in the art without deviating from the spirit and scope of the present disclosure.

In some embodiments, either or both of the filters 256, 260 may be configured to detect a pressure differential across the filter, due to contaminant buildup, and indicate when the filter needs to be serviced. For example, in some embodiments, the primary filter 260 can include a filter medium supported within a frame and a differential pressure detector incorporated into the frame. The differential pressure detector can signal when the pressure differential across the primary filter 260 reaches a threshold value due to contaminant buildup within the filter medium. The differential pressure detector can include circuitry that wirelessly signals an application stored on a mobile device to display a notification when the primary filter 260 needs to be cleaned or replaced to minimize energy consumption by the HVAC system 108. Further details pertaining to incorporating differential pressure detectors into air filters may be found in U.S. Provisional Application, entitled “Air Filter System For Detecting A Pressure Differential To Indicate A Need For Servicing,” filed on Dec. 12, 2023, and having application Ser. No. 63/609,110, the entirety of which application is incorporated herein by reference and made a part of the present disclosure.

In some embodiments, either or both of the filters 256, 260 may be configured to detect mechanical strain on the filter, due to contaminant buildup, and indicate when the filter needs to be serviced. In one embodiment, for example, the primary filter 260 comprises a filter medium supported within a frame and a mechanical strain detector incorporated into the frame. The mechanical strain detector signals when the force acting on the primary filter 260 reaches a threshold value due to contaminant buildup within the filter medium. The mechanical strain detector includes circuitry that wirelessly signals an application stored on a mobile device to display a notification when the primary filter 260 needs to be cleaned or replaced to minimize energy consumption by the HVAC system 108. Further details pertaining to air filters configured to detect mechanical strain can be found in U.S. Provisional Application, entitled “Air Filter System For Detecting Mechanical Strain To Indicate A Need For Servicing,” filed on Dec. 12, 2023, and having application Ser. No. 63/609,280, the entirety of which application is incorporated herein by reference and made a part of the present disclosure.

In some embodiments, either or both of the filters 256, 260 may be configured to detect a temperature differential across the filter, due to contaminant buildup, and indicate when the filter needs to be serviced. In an exemplary embodiment, the primary filter 260 comprises a filter medium supported within a frame and a differential temperature sensor incorporated into the frame. The differential temperature sensor signals when air pressure across the air filter reaches a threshold value due to contaminant buildup within the filter medium. The differential temperature sensor includes circuitry that wirelessly signals an application stored on a mobile device to display a notification when the primary filter 260 needs to be cleaned or replaced to minimize energy consumption by the HVAC system 108. Further details pertaining to air filters configured to detect a temperature differential can be found in U.S. Provisional Application, entitled “Air Filter System For Detecting A Temperature Differential To Indicate A Need For Servicing,” filed on Dec. 12, 2023, and having application Ser. No. 63/609,285, the entirety of which application is incorporated herein by reference and made a part of the present disclosure.

In some embodiments, either or both of the filters 256, 260 may be configured to detect changes in electrical properties of electrodes in the filter and determine a corresponding pressure differential across the filter, due to contaminant buildup, to indicate when the filter needs to be serviced. In some embodiments, the primary filter 260 can include a filter medium supported within a frame and a differential electrical properties detector incorporated into the frame. The differential electrical properties detector can signal when air pressure across the primary filter 260 reaches a threshold value due to contaminant buildup within the filter medium. The differential electrical properties detector can include circuitry that wirelessly signals an application stored on a mobile device to display a notification when the primary filter 260 needs to be cleaned or replaced to minimize energy consumption by the HVAC system 108. Further details pertaining to air filters configured to detect differential electrical properties can be found in U.S. Provisional Application, entitled “Air Filter System For Detecting Differential Electrical Properties To Indicate A Need For Servicing,” filed on Dec. 14, 2023, and having application Ser. No. 63/610,029, the entirety of which application is incorporated herein by reference and made a part of the present disclosure.

In some embodiments, either or both of the filters 256, 260 may be configured to detect changes in optical properties of the filter and determine a corresponding pressure differential across the filter, due to contaminant buildup, to indicate when the filter needs to be serviced. For example, in some embodiments, primary filter 260 comprises a filter medium supported within a frame and a differential optical properties detector incorporated into the frame. The differential optical properties detector signals when air pressure across the primary filter 260 reaches a threshold value due to contaminant buildup within the filter medium. The differential optical properties detector includes circuitry that wirelessly signals an application stored on a mobile device to display a notification when the primary filter 260 needs to be cleaned or replaced to minimize energy consumption by the HVAC system 108. Further details pertaining to air filters configured to detect differential optical properties can be found in U.S. Provisional Application, entitled “Air Filter System For Detecting Differential Optical Properties To Indicate A Need For Servicing,” filed on Dec. 14, 2023, and having application Ser. No. 63/610,076, the entirety of which application is incorporated herein by reference and made a part of the present disclosure.

In some embodiments, either or both of the filters 256, 260 may be configured to detect passive vibrations of the filter, due to contaminant buildup, and indicate when the filter needs to be serviced. For example, in some embodiments, the primary filter 260 may comprise a filter medium supported within a frame and a resonant characteristics detector incorporated into the frame. The resonant characteristics detector may be configured to signal when the force acting on the primary filter 260 reaches a threshold value due to contaminant buildup within the filter medium. The resonant characteristics detector may include circuitry that wirelessly signals an application stored on a mobile device to display a notification when the primary filter 260 needs to be cleaned or replaced to minimize energy consumption by the HVAC system 108. Further details pertaining to air filters configured to detect air filter vibration differences can be found in U.S. Provisional Application, entitled “Air Filter Vibration Differences To Indicate Contaminant Buildup,” filed on Dec. 14, 2023, and having application Ser. No. 63/610,056, the entirety of which application is incorporated herein by reference and made a part of the present disclosure.

While the reusable multi-pocket air filter and methods have been described in terms of particular variations and illustrative figures, those of ordinary skill in the art will recognize that the reusable multi-pocket air filter is not limited to the variations or figures described. In addition, where methods and steps described above indicate certain events occurring in certain order, those of ordinary skill in the art will recognize that the ordering of certain steps may be modified and that such modifications are in accordance with the variations of the reusable multi-pocket air filter. Additionally, certain of the steps may be performed concurrently in a parallel process, when possible, as well as performed sequentially as described above. To the extent there are variations of the reusable multi-pocket air filter, which are within the spirit of the disclosure or equivalent to the reusable multi-pocket air filter found in the claims, it is the intent that this patent will cover those variations as well. Therefore, the present disclosure is to be understood as not limited by the specific embodiments described herein, but only by scope of the appended claims.

What is claimed is:

1. An apparatus for a multi-pocket V-bank air filter to clean air in interior building environments, comprising:
a multiplicity of reusable filter bags for filtering an airstream;
a frame for supporting the multiplicity of filter bags in one or more V-configurations within an HVAC system;
elongated openings disposed in the frame for allowing the airstream to flow through the frame; and
filter bag retainers disposed in the elongate openings for coupling the filter bags with the frame.

2. The apparatus of claim 1, wherein the frame is formed of a rigid material suitable for supporting the multiplicity of filter bags within the HVAC system.

3. The apparatus of claim 1, wherein the frame comprises a first end, a second end, and multiple ribs arranged parallelly therebetween.

4. The apparatus of claim 3, wherein the first end and the second end each includes a series of rounded end portions that define opposite ends of the elongated openings.

5. The apparatus of claim 4, wherein the frame orients the multiplicity of filter bags within the HVAC system such that the return airstream is directed through the filter bags.

6. The apparatus of claim 5, wherein the elongated openings keep entrances into the filter bags open to allow the return airstream to flow through the frame into the filter bags.

7. The apparatus of claim 6, wherein the first end and the second end are configured to offset adjacent elongated openings to support the multiplicity of filter bags in the V-configuration within an HVAC system.

8. The apparatus of claim 7, wherein the first end, the second end, the rounded end portions, and the ribs comprise separate components that can be assembled to offset the elongated openings.

9. The apparatus of claim 8, wherein the elongated openings comprise preassembled portions that can be retained in position by first end and the second end.

10. The apparatus of claim 9, wherein the first end and the second end include seats configured to engage with rounded end portions comprising opposite ends of the elongated openings to hold the elongated openings in fixed positions.

11. The apparatus of claim 10, wherein the first end, the second end, the rounded end portions, and the ribs comprise a single monolithic component.

12. The apparatus of claim 1, wherein the elongated openings are arranged between the first end and the second end such that the multiplicity of filter bags extend into the one or more V-configurations downstream of the frame when the return airstream flows into the filter bags.

13. The apparatus of claim 12, wherein the one or more V-configurations are configured to provide a relatively greater spacing between adjacent filter bags and reduce resistance to airflow the filter bags.

14. The apparatus of claim 1, wherein an upstream panel air filter is coupled with the frame.

15. The apparatus of claim 14, wherein the panel air filter comprises a primary filter while the multiplicity of reusable filter bags comprises a secondary filter.

16. The apparatus of claim 15, wherein the primary filter has a lower MERV rating than the MERV rating of the secondary filter.

17. The apparatus of claim 16, wherein the primary filter is coupled with the secondary filter by way of a hinge and a clasp.

18. The apparatus of claim 17, wherein the primary filter is configured to be easily removed, cleaned, and reinstalled into the HVAC system to preserve the operating efficiency of the HVAC system.

19. The apparatus of claim 17, wherein the primary filter is configured to be uninstalled from the secondary filter without the secondary filter having to be removed from the HVAC system.

20. The apparatus of claim 17, wherein the primary filter is configured to receive a filter oil composition that enables the primary filter to capture contaminants by way of interception.
